(19) United States
(12) Patent Application Publication
(10) Pub. No.: US 2024/0427599 A1
(43) Pub. Date: Dec. 26, 2024

(54) PROVIDING PHYSICAL REGISTER (PR) SWAP MEMORY RENAMING IN PROCESSOR-BASED DEVICES

(71) Applicant: QUALCOMM Incorporated, San Diego, CA (US)

(72) Inventors: Akilesh Krishnamurthy, San Jose, CA (US); Conrado Blasco, San Mateo, CA (US); Paul Kitchin, Austin, TX (US); Aniket Bhivasen Bhor, Santa Clara, CA (US)

(21) Appl. No.: 18/339,529

(22) Filed: Jun. 22, 2023

(51) Int. Cl. G06F 9/30; G06F 9/38

(52) U.S. Cl. CPC G06F 9/30079; G06F 9/30145; G06F 9/3838

(57) ABSTRACT

Providing physical register (PR) swap memory renaming in processor-based devices is disclosed herein. In some exemplary aspects, a processor provides an instruction processing circuit comprising a scheduling stage circuit and an execution stage circuit. The scheduling stage circuit comprises a reservation station circuit, while the execution stage circuit comprises a PR swap table storing a plurality of PR swap table entries. The scheduling stage circuit issues a first instruction that is associated with a store dependency ID. The execution stage circuit, in response to the issuing of the first instruction, identifies a PR swap table entry among the plurality of PR swap table entries corresponding to the store dependency ID, retrieves a load dependency ID of the PR swap table entry, and broadcasts the load dependency ID to the reservation station circuit to wake a second instruction that is associated with the load dependency ID.

### BACKGROUND

### I. Field of the Disclosure

The technology of the disclosure relates generally to mechanisms for handling memory dependencies in processor-based devices.

### II. Background

Instruction pipelining is a processing technique whereby the throughput of instructions being executed by a processor-based device may be increased by splitting the handling of each instruction into a series of steps. These steps are executed in an instruction processing circuit that provides one or more instruction pipelines that each comprise multiple stages. Optimal processor performance may be achieved if all stages in a given instruction pipeline are able to process instructions concurrently. Processor efficiency may be further improved using out-of-order processing, in which instructions are executed in an order based on the availability of input data required by each instruction and the availability of an appropriate execution unit, rather than the program order of the instructions. An out-of-order processor can execute an instruction as soon as all input data to be consumed by the instruction has been produced, which enables processor cycles that would otherwise be wasted waiting for earlier instructions to complete to be productively used.

The degree to which out-of-order processing can improve processor efficiency may be limited based on data dependencies that can arise between instructions to be executed. These data dependencies may include “false dependencies” (e.g., write-after-write (WAW) dependencies and write-after-read (WAR) dependencies) as well as “true dependencies” (e.g., read-after-write (RAW) dependencies). Data dependencies limit the ability of an out-of-order processor to reorder instructions or perform parallel execution of instructions. For instance, reordering and parallel execution are prevented by WAW dependencies where instruction order affects the final output value of a variable, by WAR dependencies where an instruction requires a value that is later modified, and by RAW dependencies where a subsequent instruction depends on a result generated by a previous instruction.

False dependencies can be addressed using a technique known as register renaming, which involves mapping instruction operands that are specified as architectural registers (i.e., registers that are explicitly provided by an instruction set architecture or ISA) to physical registers (PRs), of which the processor-based device may provide many more than the number of architectural registers. Using register renaming, false dependencies that may arise from the reuse of the same architectural registers by instructions that do not have actual data dependencies between them can be eliminated. Register renaming mechanisms in conventional processor-based devices allocate PR tags to each destination PR (i.e., each PR to which data is written by an instruction), and use the PR tags to track dependent instructions in a reservation station of the instruction pipeline's scheduling stage. When an instruction issues, the PR tags corresponding to the instruction's destination PRs are broadcast within the reservation station to “wake” any instructions that use those PRs as a source of data.

However, register renaming in general, and the use of PR tags in particular, are not sufficient to eliminate and track true dependencies between instructions. For example, in instances in which a first instruction stores data to a memory address stored in a first PR and then a second instruction reads the data from the same memory address stored in a second PR, the dependency between the second instruction and the first instruction cannot be tracked by PR tags because the same memory address may have different PR “identities.” To address these types of dependencies, a technique known as memory renaming may be used. Memory renaming mechanisms attempt to predict a dependence between a store instruction and a subsequent load instruction, and then speculatively bypass the store instruction and the load instruction. Memory renaming is conventionally implemented in the “front end” of the instruction pipeline, and uses a large table to track pairs of store instructions and load instructions. Consequently, these conventional memory renaming mechanisms may be expensive in terms of processor area and power consumption. Additionally, memory renaming mechanisms are frequently accessed before a rename stage of the instruction pipeline, which may present difficult timing challenges for wide out-of-order processors with shallow pipelines.

Due to the potentially out-of-order nature of load instructions and store instructions, a further issue that may arise relates to operations performed by a load-store unit (LSU) in an execution stage of the instruction pipeline. When the LSU detects a memory dependence between a store instruction and a load instruction, the load instruction is placed in a load queue of the LSU to wait until data is available from the store instruction. At that point, the LSU issues a load replay to the reservation station, and wakes any instructions that are dependent on the load instruction. The load replay process may consume multiple processor cycles, and can negatively impact processor performance. Accordingly, it is desirable to avoid the latency of the load replay while incurring only minimal design, processing, and power overhead.

### SUMMARY OF THE DISCLOSURE

Aspects disclosed in the detailed description include providing physical register (PR) swap memory renaming in processor-based devices. Related apparatus, methods, and computer-readable media are also disclosed. In this regard, in some exemplary aspects disclosed herein, a processor-based device comprises an instruction processing circuit that includes multiple pipeline stage circuits, including an execution stage circuit and a scheduling stage circuit. The execution stage circuit comprises a PR swap table that stores a plurality of PR swap table entries. Each of the PR swap table entries includes a store dependency identifier (ID) (e.g., a PR tag of a PR from which a store instruction reads, or a reorder buffer (ROB) ID or a scheduler ID of the store instruction) and a load dependency ID (e.g., a PR tag of a PR to which a corresponding load instruction writes, or a ROB ID or a scheduler ID of the load instruction). When the scheduling stage circuit issues a first instruction that is associated with the store dependency ID, the execution stage circuit identifies the PR swap table entry corresponding to the store dependency ID. The execution stage circuit then retrieves the load dependency ID of the PR swap table entry, and broadcasts the load dependency ID to a reservation station circuit of the scheduling stage circuit to wake a second instruction that is associated with the load dependency ID.

According to some aspects in which the load dependency ID is a ROB ID or a scheduler ID of the load instruction, the PR swap table entry may further store a load data PR tag, which may be used for register file updates. Some aspects that enable support for different register types (e.g., integer and vector registers) may provide that the PR swap table entry may store a register type indication to indicate a register type associated with the PR swap table entry. In such aspects, the execution stage circuit may identify the PR swap table entry by determining that the register type indication of the PR swap table entry corresponds to a register type of a first PR of the first instruction. Some aspects may provide that the PR swap table entry comprises a memory size indication to provide support for different load memory sizes.

In some aspects, a load-store unit (LSU) circuit of the execution stage circuit may be configured to allocate the PR swap table entry by first detecting an address dependency between the store instruction and the load instruction. The LSU circuit also determines that the load instruction is resident in a load queue of the LSU and is awaiting store data. In response to detecting the address dependency and determining that the load instruction is resident in the load queue, the LSU circuit allocates the PR swap table entry in the PR swap table (e.g., by determining the store dependency ID and the load dependency ID based on the store instruction and the load instruction, respectively, and storing the store dependency ID and the load dependency ID as part of the PR swap table entry).

According to some aspects, the PR swap table entry may be allocated in an earlier stage of the instruction processing circuit based on a conventional “front end” predictive scheme. In such aspects, a decode stage circuit or a rename stage circuit predicts an address dependency between the store instruction and the load instruction, and, in response to the prediction of the address dependency, the rename stage circuit allocates the PR swap table entry in the PR swap table. The LSU circuit subsequently verifies the prediction of the address dependency during issuance of the load instruction or replay of the load instruction.

Some aspects may provide that, upon execution of the first instruction by the execution stage circuit, a writeback stage circuit of the instruction processing circuit is configured to write a result of the execution of the first instruction into a first PR indicated by the first instruction in a register file. The writeback stage circuit also writes the result of the execution of the first instruction into a second PR in the register file (i.e., a PR subsequently accessed by the second instruction). When the scheduling stage circuit issues the second instruction, the execution stage circuit is configured to read data corresponding to the second PR from one of the register file and an intermediate bypass stage of the instruction processing circuit.

In another aspect, a processor-based device is provided. The processor-based device comprises a processor that provides an instruction processing circuit comprising a plurality of pipeline stage circuits, including a scheduling stage circuit and an execution stage circuit. The scheduling stage circuit comprises a reservation station circuit, while the execution stage circuit comprises a PR swap table storing a plurality of PR swap table entries. The scheduling stage circuit is configured to issue a first instruction that is associated with a store dependency ID. The execution stage circuit is configured to, responsive to the issuing of the first instruction, identify a PR swap table entry corresponding to the store dependency ID among the plurality of PR swap table entries of the PR swap table. The execution stage circuit is further configured to retrieve a load dependency ID of the PR swap table entry, and broadcast the load dependency ID to the reservation station circuit to wake a second instruction that is associated with the load dependency ID.

In another aspect, a processor-based device is provided. The processor-based device comprises means for issuing a first instruction that is associated with a store dependency ID. The processor-based device further comprises means for identifying a PR swap table entry corresponding to the store dependency ID among a plurality of PR swap table entries of a PR swap table, responsive to the issuing of the first instruction. The processor-based device also comprises means for retrieving a load dependency ID of the PR swap table entry. The processor-based device additionally comprises means for broadcasting the load dependency ID to a reservation station circuit to wake a second instruction that is associated with the load dependency ID.

In another aspect, a method for providing PR swap memory renaming in processor-based devices is provided. The method comprises issuing, by a scheduling stage circuit of an instruction processing circuit of a processor, a first instruction that is associated with a store dependency ID. The method further comprises, responsive to the issuing of the first instruction, identifying, by an execution stage circuit of the instruction processing circuit of the processor, a PR swap table entry corresponding to the store dependency ID among a plurality of PR swap table entries of a PR swap table of the execution stage circuit. The method also comprises retrieving, by the execution stage circuit, a load dependency ID of the PR swap table entry. The method additionally comprises broadcasting, by the execution stage circuit, the load dependency ID to a reservation station circuit of the scheduling stage circuit to wake a second instruction that is associated with the load dependency ID.

In another aspect, a non-transitory computer-readable medium is provided. The non-transitory computer-readable medium stores thereon computer-executable instructions that, when executed by a processor of a processor-based device, cause the processor to issue a first instruction that is associated with a store dependency ID. The computer-executable instructions further cause the processor to identify a PR swap table entry corresponding to the store dependency ID among a plurality of PR swap table entries of a PR swap table, responsive to the issuing of the first instruction. The computer-executable instructions also cause the processor to retrieve a load dependency ID of the PR swap table entry. The computer-executable instructions additionally cause the processor to broadcast the load dependency ID to a reservation station circuit to wake a second instruction that is associated with the load dependency ID.

### BRIEF DESCRIPTION OF THE FIGURES

FIG. 1 is a block diagram of an exemplary processor-based device configured to provide physical register (PR) swap memory renaming, according to some aspects;

FIGS. 2A-2B are block diagrams illustrating exemplary elements of and operations performed by the execution stage circuit and the scheduling stage circuit of FIG. 1 for providing PR swap memory renaming, according to some aspects;

FIGS. 3A-3D are block diagrams illustrating exemplary constituent elements of the PR swap table entries of the PR swap table of FIG. 1, according to some aspects;

FIGS. 4A-4B provide a flowchart illustrating exemplary operations for providing PR swap memory renaming, according to some aspects;

FIG. 5 provides a flowchart illustrating exemplary operations for allocation of a PR swap table entry by a load-store unit (LSU) circuit of FIG. 1, according to some aspects;

FIG. 6 provides a flowchart illustrating exemplary operations for allocation of a PR swap table entry by a decode stage circuit and/or a rename stage circuit of FIG. 1, according to some aspects; and

FIG. 7 is a block diagram of an exemplary processor-based device that can include the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like (e.g., “first instruction” and “second instruction”) are used herein to distinguish between similarly named elements, and are not intended to indicate an ordinal relationship between such elements unless described as such herein.

Aspects disclosed in the detailed description include providing physical register (PR) swap memory renaming in processor-based devices. Related apparatus, methods, and computer-readable media are also disclosed. In this regard, in some exemplary aspects disclosed herein, a processor-based device comprises an instruction processing circuit that includes multiple pipeline stage circuits, including an execution stage circuit and a scheduling stage circuit. The execution stage circuit comprises a PR swap table that stores a plurality of PR swap table entries. Each of the PR swap table entries includes a store dependency identifier (ID) (e.g., a PR tag of a PR from which a store instruction reads, or a reorder buffer (ROB) ID or a scheduler ID of the store instruction) and a load dependency ID (e.g., a PR tag of a PR to which a corresponding load instruction writes, or a ROB ID or a scheduler ID of the load instruction). When the scheduling stage circuit issues a first instruction that is associated with the store dependency ID, the execution stage circuit identifies the PR swap table entry corresponding to the store dependency ID. The execution stage circuit then retrieves the load dependency ID of the PR swap table entry, and broadcasts the load dependency ID to a reservation station circuit of the scheduling stage circuit to wake a second instruction that is associated with the load dependency ID.

According to some aspects in which the load dependency ID is a ROB ID or a scheduler ID of the load instruction, the PR swap table entry may further store a load data PR tag, which may be used for register file updates. Some aspects that enable support for different register types (e.g., integer and vector registers) may provide that the PR swap table entry may store a register type indication to indicate a register type associated with the PR swap table entry. In such aspects, the execution stage circuit may identify the PR swap table entry by determining that the register type indication of the PR swap table entry corresponds to a register type of a first PR of the first instruction. Some aspects may provide that the PR swap table entry comprises a memory size indication to provide support for different load memory sizes.

In some aspects, a load-store unit (LSU) circuit of the execution stage circuit may be configured to allocate the PR swap table entry by first detecting an address dependency between the store instruction and the load instruction. The LSU circuit also determines that the load instruction is resident in a load queue of the LSU and is awaiting store data. In response to detecting the address dependency and determining that the load instruction is resident in the load queue, the LSU circuit allocates the PR swap table entry in the PR swap table (e.g., by determining the store dependency ID and the load dependency ID based on the store instruction and the load instruction, respectively, and storing the store dependency ID and the load dependency ID as part of the PR swap table entry).

According to some aspects, the PR swap table entry may be allocated in an earlier stage of the instruction processing circuit based on a conventional “front end” predictive scheme. In such aspects, a decode stage circuit or a rename stage circuit predicts an address dependency between the store instruction and the load instruction, and, in response to the prediction of the address dependency, the rename stage circuit allocates the PR swap table entry in the PR swap table. The LSU circuit subsequently verifies the prediction of the address dependency during issuance of the load instruction or replay of the load instruction.

Some aspects may provide that, upon execution of the first instruction by the execution stage circuit, a writeback stage circuit of the instruction processing circuit is configured to write a result of the execution of the first instruction into a first PR indicated by the first instruction in a register file. The writeback stage circuit also writes the result of the execution of the first instruction into a second PR in the register file (i.e., a PR subsequently accessed by the second instruction). When the scheduling stage circuit issues the second instruction, the execution stage circuit is configured to read data corresponding to the second PR from one of the register file and an intermediate bypass stage of the instruction processing circuit.

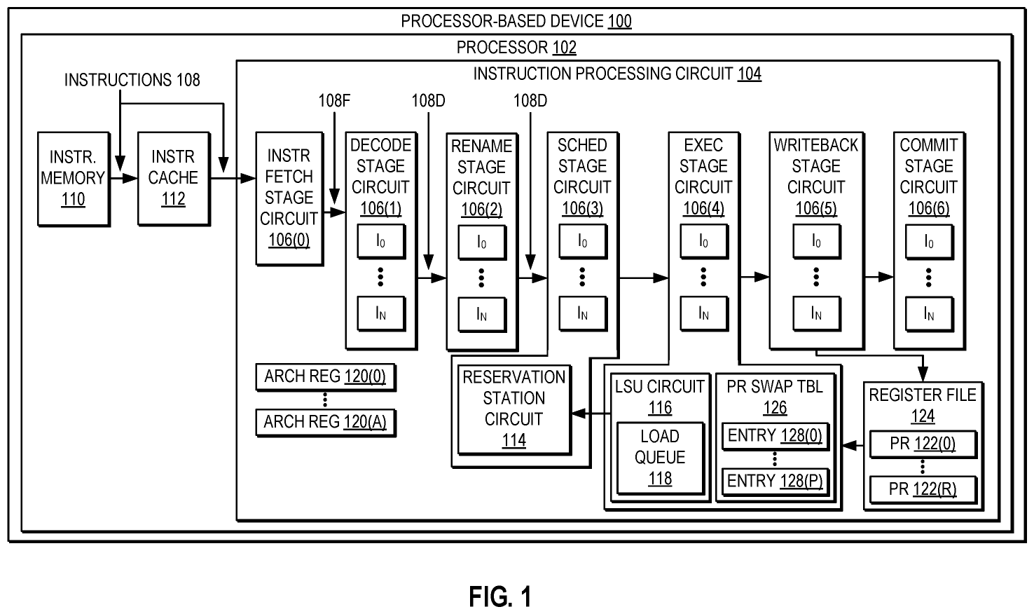

In this regard, FIG. 1 is a diagram of an exemplary processor-based device 100 that includes a processor 102. The processor 102, which also may be referred to as a “processor core” or a “central processing unit (CPU) core,” is an out-of-order processor, and may be one of a plurality of processors 102 provided by the processor-based device 100. In the example of FIG. 1, the processor 102 includes an instruction processing circuit 104 that comprises multiple stage circuits including an instruction fetch stage circuit (captioned as “INSTR FETCH STAGE CIRCUIT” in FIG. 1) 106(0), a decode stage circuit 106(1), a rename stage circuit 106(2), a scheduling stage circuit (captioned as “SCHED STAGE CIRCUIT” in FIG. 1) 106(3), an execution stage circuit (captioned as “EXEC STAGE CIRCUIT” in FIG. 1) 106(4), a writeback stage circuit 106(5), and a commit stage circuit 106(6), which may be collectively referred to herein as a “plurality of pipeline stage circuits 106” or “pipeline stage circuits 106.” The instruction processing circuit 104 also includes one or more instruction pipelines I0-IN for processing instructions 108 fetched from an instruction memory (captioned as “INSTR MEMORY” in FIG. 1) 110 by the instruction fetch stage circuit 106(0) for execution. The instruction memory 110 may be provided in or as part of a system memory in the processor-based device 100, as a non-limiting example. An instruction cache (captioned as “INSTR CACHE” in FIG. 1) 112 may also be provided in the processor 102 to cache the instructions 108 fetched from the instruction memory 110 to reduce latency in the instruction fetch stage circuit 106(0).

The instruction fetch stage circuit 106(0) in the example of FIG. 1 is configured to provide the instructions 108 as fetched instructions 108F into the one or more instruction pipelines I0-IN in the instruction processing circuit 104 to be pre-processed, before the fetched instructions 108F reach the execution stage circuit 106(4) to be executed. The fetched instructions 108F may include producer instructions and corresponding consumer instructions that consume data produced as a result of the instruction processing circuit 104 executing the producer instructions. The instruction pipelines I₀-I_{N} are provided across the pipeline stage circuits 106 of the instruction processing circuit 104 to pre-process and process the fetched instructions 108F in a series of steps that can be performed concurrently to increase throughput prior to execution of the fetched instructions 108F by the execution stage circuit 106(4).

With continuing reference to FIG. 1, the decode stage circuit 106(1) is configured to decode each of the fetched instructions 108F fetched by the instruction fetch stage circuit 106(0) into corresponding decoded instructions 108D to determine, e.g., opcodes, operands, addressing modes, instruction types, and/or actions required, as non-limiting examples. Data such as the instruction type and action required encoded in the decoded instructions 108D may also be used to determine into which instruction pipeline I₀-I_{N} the decoded instructions 108D should be placed. In this example, the decoded instructions 108D are placed into one or more of the instruction pipelines I₀-I_{N} and are next provided to the rename stage circuit 106(2) in the instruction processing circuit 104. The rename stage circuit 106(2) is configured to determine if any register names in the decoded instructions 108D should be renamed to decouple any register dependencies that would prevent parallel or out-of-order processing.

The decoded instructions 108D are then provided to the scheduling stage circuit 106(3). The scheduling stage circuit 106(3) is configured to store each of the decoded instructions 108D in reservation entries (not shown) of a reservation station circuit 114 until all register operands for the decoded instruction 108D are ready and a suitable execution unit is available. For example, the scheduling stage circuit 106(3) is responsible for determining whether the necessary values for operands of a decoded consumer instruction 108D are available before issuing the decoded consumer instruction 108D for execution. When the operands are available, the scheduling stage circuit 106(3) is configured to issue a wake-up signal (not shown) to “wake up” the decoded consumer instruction 108D (i.e., indicate that the decoded consumer instruction 108D is now eligible for issuance) in the reservation station circuit 114 in response to issuance of a producer instruction to the execution stage circuit 106(4). The wake-up signal indicates that a produced value from execution of the issued producer instruction will be available, and thus the consumer instruction of the producer instruction is eligible for issuance to the execution stage circuit 106(4) behind the producer instruction. Some aspects may provide that the scheduling stage circuit 106(3) comprises multiple reservation station circuits 114, each of which may be configured to issue instructions among the decoded instructions 108D to different execution units (not shown) of the execution stage circuit 106(4).

The instructions 108 are next passed to the execution stage circuit 106(4) for execution. The execution stage circuit 106(4) in the example of FIG. 1 comprises a load-store unit (LSU) circuit (captioned as “LSU CIRCUIT” in FIG. 1) 116 (e.g., as part of an execution unit (not shown)) that is configured to handle execution of load instructions and store instructions, including generating corresponding virtual addresses and loading data from or storing data to memory. The LSU circuit 116 in FIG. 1 includes a load queue 118, which may be used as a waiting area for load instructions (not shown) that are dependent on data that is not yet available. In some aspects, the LSU circuit 116 may include additional data structures not shown in FIG. 1, such as a store queue for holding store instructions that have not yet been committed. The execution stage circuit 106(4) according to some aspects may further comprise additional execution units (not shown), each of which may be configured to execute instructions issued by a corresponding reservation station circuit such as the reservation station circuit 114 of the scheduling stage circuit 106(3).

After the instructions 108 are executed, the writeback stage circuit 106(5) writes results of instruction execution to memory (such e.g., cache or system memory, as non-limiting examples) or a register. Finally, the commit stage circuit 106(6) updates the architectural state of the processor 102 to reflect the results of instruction execution. It is to be understood that the instruction processing circuit 104 in some aspects may include more, fewer, or different pipeline stage circuits 106 than illustrated in FIG. 1.

To improve out-of-order execution of the instructions 108, the processor-based device 100 of FIG. 1 is configured to provide register renaming functionality. In this regard, the processor 102 provides a plurality of architectural registers (captioned as “ARCH REG” in FIG. 1) 120(0)-120(A), which may also be referred to as “logical registers.” During instruction execution, the architectural registers 120(0)-120(A) may be mapped (e.g., using a map table (not shown)) to corresponding physical registers (captioned as “PR” in FIG. 1) 122(0)-122(R) stored in a register file 124. The register file 124 may comprise, as non-limiting examples, an integer register file or a vector register file, and may be one of multiple register files provided by the processor-based device 100. The number R of physical registers 122(0)-122(R) of the register file 124 may be greater than the number A of architectural registers 120(0)-120(A) in some aspects. Register renaming using the physical registers 122(0)-122(R) enables the processor-based device 100 to detect and eliminate false dependencies (e.g., write-after-write (WAW) and write-after-read (WAR) dependencies) between the instructions 108.

However, as noted above, register renaming is not sufficient to eliminate and track “true dependencies” (e.g., read-after-write (RAW) dependencies) between the instructions 108. While memory renaming mechanisms may be conventionally used to handle true dependencies, such mechanisms may be expensive in terms of processor area and power consumption, and may present timing challenges due to their implementation in the “front end” of the instruction processing circuit 104 (i.e., in one of the stages prior to the execution stage circuit 106(4)). In addition, when the LSU circuit 116 detects a memory dependence between a store instruction and a load instruction, the load instruction is placed in the load queue 118 of the LSU circuit 116 to wait until store data is available. At that point, the LSU circuit 116 issues a load replay to the reservation station circuit 114, and wakes any instructions that are dependent on the load instruction. The load replay process may consume multiple processor cycles, and can negatively impact processor performance.

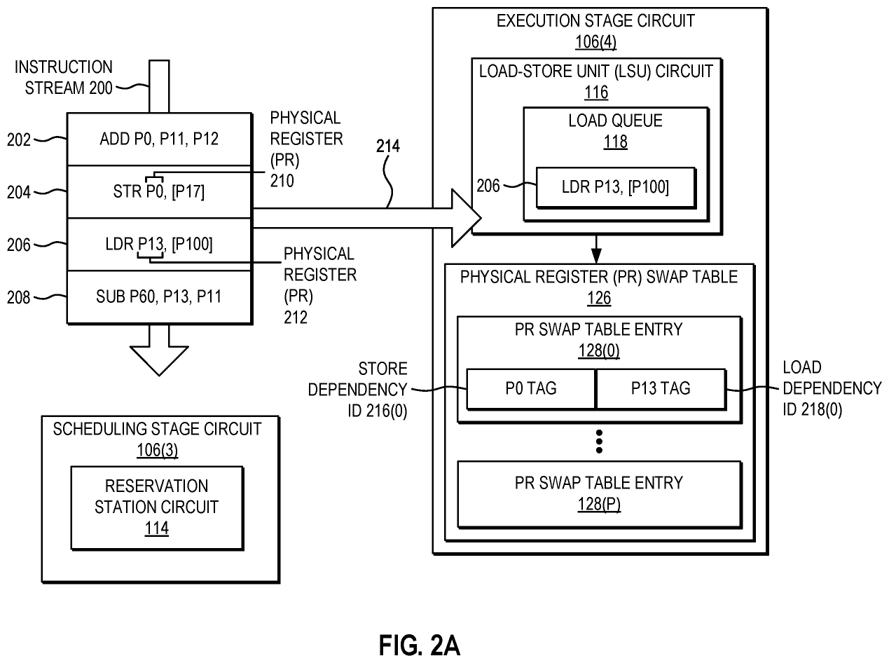

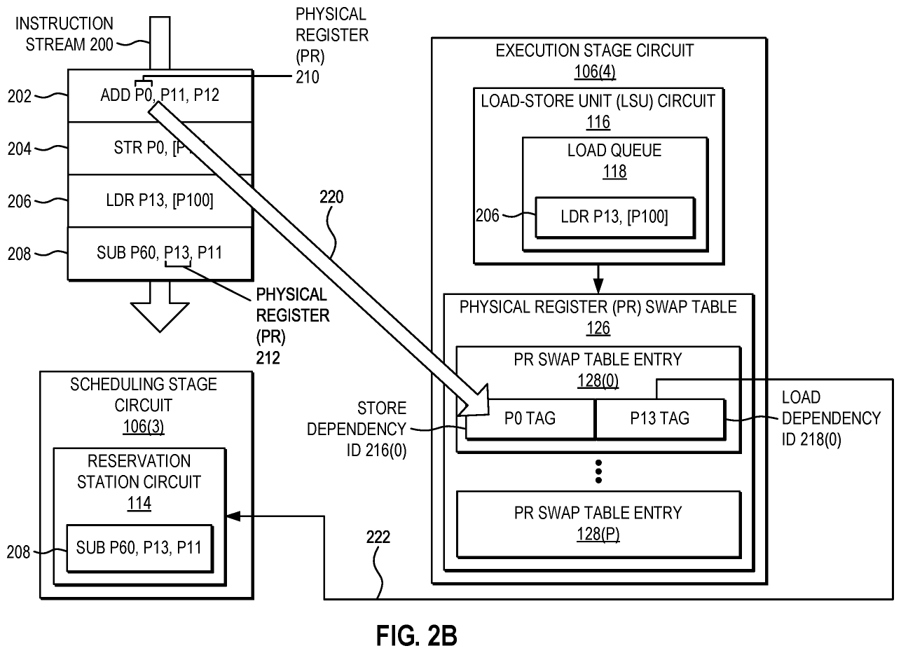

In this regard, the execution stage circuit 106(4) provides a PR swap table (captioned as “PR SWAP TBL” in FIG. 1) 126 comprising a plurality of PR swap table entries (captioned as “ENTRY” in FIG. 1) 128(0)-128(P). As discussed in greater detail below with respect to FIGS. 2A-2B, the PR swap table 126 may be used to implement an opportunistic memory renaming technique that allows the load replay process conventionally performed by the LSU circuit 116 to be avoided, with minimal impact on processor design, area, and power consumption, and without introducing timing challenges.

FIGS. 2A-2B illustrate exemplary elements of and operations performed by the execution stage circuit 106(4) and the scheduling stage circuit 106(3) of FIG. 1 for providing PR swap memory renaming. In FIGS. 2A-2B, the execution stage circuit 106(4), the LSU circuit 116, the load queue 118, the PR swap table 126, the plurality of PR swap table entries 128(0)-128(P), the scheduling stage circuit 106(3), and the reservation station circuit 114 of FIG. 1 are shown. In addition, an instruction stream 200 being processed by the instruction processing circuit 104 of FIG. 1 is shown. The instruction stream 200 includes a first instruction 202 (captioned as “ADD” in FIGS. 2A-2B), a store instruction 204 (captioned as “STR” in FIGS. 2A-2B), a load instruction 206 (captioned as “LDR” in FIGS. 2A-2B), and a second instruction 208 (captioned as “SUB” in FIGS. 2A-2B). When executed, the first instruction 202 performs an ADD (addition) operation on values stored in PRs P11 and P12, and stores the result in PR P0 (also referred to herein as “physical register 210” or “PR 210”). The store instruction 204 then writes the result stored in P0 to a memory address (e.g., 0xA, as an example) stored in PR P15. The load instruction 206 subsequently reads the value at a memory address stored in PR P100 (in this example, the same memory address 0xA), and writes the value to PR P13 (also referred to herein as “physical register 212” or “PR 212”). Finally, the second instruction 208 performs a SUB (subtraction) operation using values stored in P13 and P11, and writes the result to PR P60. It is to be understood that the examples shown in FIGS. 2A-2B assume the use of an integer register file for performing memory renaming for the corresponding instructions. In aspects in which a vector register file is used for memory renaming, the corresponding instructions “ADD” and “SUB” may be replaced by appropriate floating-point instructions such as FADD and FSUB instructions.

In conventional operation, the LSU circuit 116 detects an address dependence between the store instruction 204 and the load instruction 206, because the load instruction 206 is attempting to read from the same memory address 0xA to which the store instruction 204 is writing. The LSU circuit 116 would place the load instruction 206 in the load queue 118 until where it would wait until store data is available at the memory address 0xA. Note that execution of the second instruction 208 would also be stalled, because it is dependent on P13, the PR to which the load instruction 206 writes, as a source of data. When the store data eventually becomes available, the LSU circuit 116 would issue a load replay to the reservation station circuit 114, and would wake the second instruction 208. As noted above, though, this load replay process may consume multiple processor cycles, and can negatively impact performance of the processor-based device 100 of FIG. 1.

Thus, to avoid the latency of the conventional load replay process, the LSU circuit 116 in exemplary operation first detects the address dependency between the store instruction 204 and the load instruction 206, as indicated by arrow 214 in FIG. 2A. The LSU circuit 116 also determines that the load instruction 206 is resident in the load queue 118 and is awaiting store data. In response to detecting the address dependency and determining that the load instruction 206 is resident in the load queue 118, the LSU circuit 116 allocates the PR swap table entry 128(0) in the PR swap table 126. As seen in FIG. 2A, the PR swap table entry 128(0) includes a store dependency ID 216(0) and a load dependency ID 218(0). The LSU circuit 116 in the example of FIG. 2A determines the store dependency ID 216(0) as the PR tag of P0 (“P0 TAG”), and further determines the load dependency ID 218(0) as the PR tag of P13 (“P13 TAG”). The LSU circuit 116 then stores the store dependency ID 216(0) and the load dependency ID 218(0) as part of the PR swap table entry 128(0). It is to be understood that some aspects may provide that the store dependency ID 216(0) and the load dependency ID 218(0) may comprise, e.g., a ROB ID of the store instruction 204 and the load instruction 206, respectively, or a scheduler ID of the store instruction 204 and the load instruction 206, respectively.

Referring now to FIG. 2B, the scheduling stage circuit 106(3) subsequently issues the first instruction 202 that is associated with the store dependency ID 216(0). In this example, the first instruction 202 writes to P0, and thus is associated with the PR tag for P0 (P0 TAG) that is stored as the store dependency ID 216(0) of the PR swap table entry 128(0). In response to the issuing of the first instruction 202, the execution stage circuit 106(4) identifies the PR swap table entry 128(0) corresponding to the store dependency ID 216(0), as indicated by arrow 220 in FIG. 2B. The execution stage circuit 106(4) retrieves the load dependency ID 218(0) (i.e., the PR tag for P13 (P13 TAG)) of the PR swap table entry 128(0), and then broadcasts the load dependency ID 218(0) to the reservation station circuit 114 to wake the second instruction 208 that is associated with the load dependency ID 218(0), as indicated by arrow 222. In the example of FIG. 2B, the second instruction 208 reads from P13, and thus is associated with the PR tag for P13 that is stored as the load dependency ID 218(0) of the PR swap table entry 128(0).

When the execution stage circuit 106(4) executes the first instruction 202, the writeback stage circuit 106(5) of FIG. 1 writes a result of the execution of the first instruction 202 into PRO indicated by the first instruction 202 in the register file 124 of FIG. 1. The writeback stage circuit 106(5) also writes the result of the execution of the first instruction 202 into P13 in the register file 124, based on the load dependency ID 218(0) of the PR swap table entry 128(0). When the scheduling stage circuit 106(3) issues the second instruction 208, the execution stage circuit 106(4) reads data corresponding to P13 from the register file 124, or from an intermediate bypass stage of the instruction processing circuit 104. In this manner, when the instruction stream 200 is being speculatively executed, the store instruction 204 and the load instruction 206 can be bypassed (although they still are executed non-speculatively to verify memory dependence predictions, perform memory fault checks, and the like). Processing performance is thus improved both by avoiding load replay as well as by speeding the speculative execution of the second instruction 208.

Note that, in some aspects, the PR swap table 126 may be extended to implement other predictive schemes. For example, some aspects of the processor-based device 100 may implement stack-based renaming using the PR swap table 126. In such aspects, the decode stage circuit 106(1) or the rename stage circuit 106(2) may be configured to predict a dependent store instruction/load instruction pair, and allocate a PR swap table entry 128(0)-128(P) in response. The PR swap table 126 would be used to perform an early broadcast in the same manner discussed above. In such aspects, the LSU circuit 116 performs a verification operation (i.e., during issuance of the load instruction or replay of the load instruction) to ensure that the dependent store instruction/load instruction pair was correctly predicted and bypassed. In the event of a misprediction, the processor 102 of FIG. 1 may recover by performing a pipeline flush and then re-executing the load instruction 206.

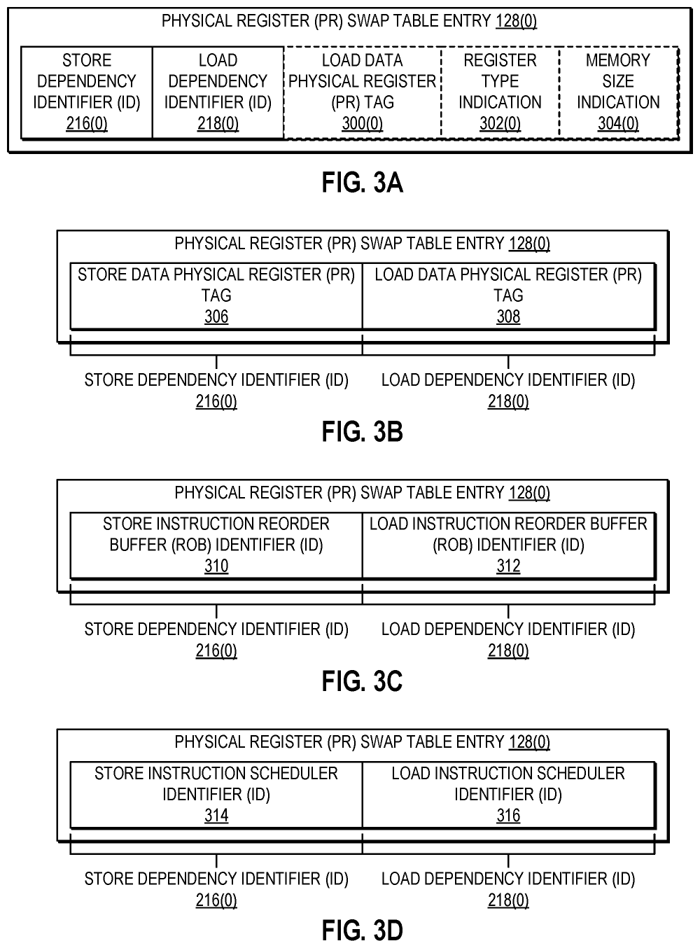

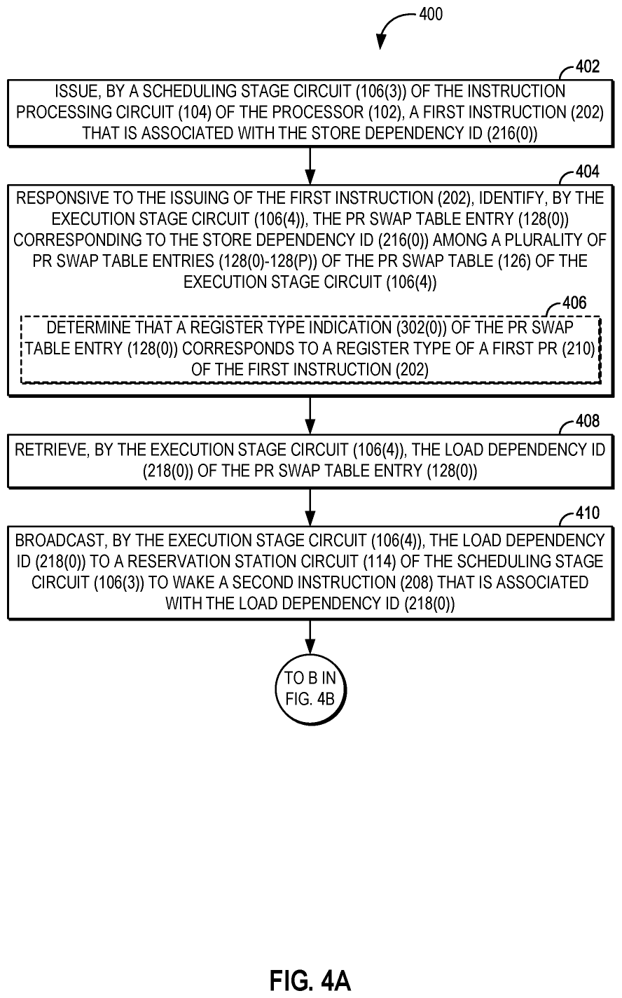

FIGS. 3A-3D illustrate exemplary constituent elements of a PR swap table entry, such as the PR swap table entry 128(0) of the PR swap table 126 of FIGS. 1 and 2A-2B, according to some aspects. In the example of FIG. 3A, the PR swap table entry comprises the store dependency ID 216(0), which is determined based on a store instruction such as the store instruction 204 of FIGS. 2A-2B, and which can be used to detect issuance of an associated instruction such as the first instruction 202 of FIGS. 2A-2B. The PR swap table entry 128(0) further comprises the load dependency ID 218(0), which is determined based on a load instruction, such as the load instruction 206, that has an address dependency on the store instruction 204. The load dependency ID 218(0) is also broadcast by the LSU circuit 116 to the reservation station circuit 114 to wake dependent instructions such as the second instruction 208 of FIGS. 2A-2B.

The PR swap table entry 128(0) in some aspects may also provide fields for storing additional metadata. For example, in aspects in which instruction dependencies are tracked using mechanisms other than PR tags, the PR swap table entry 128(0) may include a load data PR tag 300(0), which can be used when performing updates of the register file 124 of FIG. 1. Some aspects may provide that the PR swap table 126 may provide support for performing memory renaming using multiple register types, such as integer registers and vector registers, using corresponding register files (i.e., an integer register file and a vector register file, respectively). Such aspects may provide that the PR swap table entry 128(0) comprises a register type indication 302(0) to indicate the type of register associated with which the PR swap table entry 128(0) is associated. In such aspects, the LSU circuit 116 may identify the PR swap table entry 128(0) in part by determining that the register type indication 302(0) of the PR swap table entry 128(0) corresponds to a register type (e.g., integer or vector) of the PR 210 of the first instruction 202 of FIG. 2B. Subsequent updates to the register file 124 by the writeback stage circuit 106(5) of FIG. 1 may involve writing to one of an integer register file or a vector register file as indicated by the register type indication 302(0).

The PR swap table entry 128(0) according to some aspects may include a memory size indication 304(0) to provide support for any load memory size. Thus, for example, if the load instruction 206 writes a smaller value (e.g., one (1) byte) into the PR 212 in FIG. 2A than the size of the value that the first instruction 202 writes into the PR 210 (e.g., eight (8) bytes) in FIG. 2B, the memory size indication 304(0) may be set to indicate the larger size. Subsequently, the writeback stage circuit 106(5) of FIG. 1 may use the memory size indication 304(0) of the PR swap table entry 128(0) to apply zero (0) extensions when writing the results of the first instruction 202 into the PR 212. The memory size indication 304(0) of the PR swap table entry 128(0) may also be used to apply zero (0) extensions when data corresponding to the PR 212 is sent to an intermediate bypass stage of the instruction processing circuit 104.

FIGS. 3B-3D illustrates data that may be stored as the store dependency ID 216(0) and the load dependency ID 218(0) in some exemplary aspects of the PR swap table entry 128(0) based on different mechanisms used by the processor-based device 100 of FIG. 1 for tracking instruction dependencies. FIG. 3B shows an aspect in which PR tags are used to track instruction dependencies. The PR swap table entry 128(0) in such aspects stores a store data PR tag 306 (i.e., a PR tag of the PR 210 from which the store instruction 204 reads) as the store dependency ID 216(0), and further stores a load data PR tag 308 (i.e., a PR tag of the PR 212 to which the load instruction 206 writes) as the load dependency ID 218(0). As seen in FIG. 3C, aspects in which ROB IDs are used to track instruction dependencies may provide that the PR swap table entry 128(0) stores a store instruction ROB ID 310 (i.e., a ROB ID of the store instruction 204) as the store dependency ID 216(0), and also stores a load instruction ROB ID 312 (i.e., a ROB ID of the load instruction 206) as the load dependency ID 218(0). Finally, FIG. 3D illustrates an aspect in which scheduler IDs are used to track instruction dependencies. Accordingly, the PR swap table entry 128(0) in such aspects stores a store instruction scheduler ID 314 (i.e., a scheduler ID of the store instruction 204) as the store dependency ID 216(0), and also stores a load instruction scheduler ID 316 (i.e., a scheduler ID of the load instruction 206) as the load dependency ID 218(0).

It is to be understood that the aspects illustrated in FIGS. 3B-3D may include one or more of the additional metadata fields illustrated in FIG. 3A. Additionally, while only exemplary aspects of the PR swap table entry 128(0) is illustrated in FIGS. 3A-3D for the sake of clarity, it is to be understood that each of the plurality of PR swap table entries 128(0)-128(P) of FIG. 1 in such exemplary aspects would include data fields corresponding to those of the PR swap table entry 128(0).

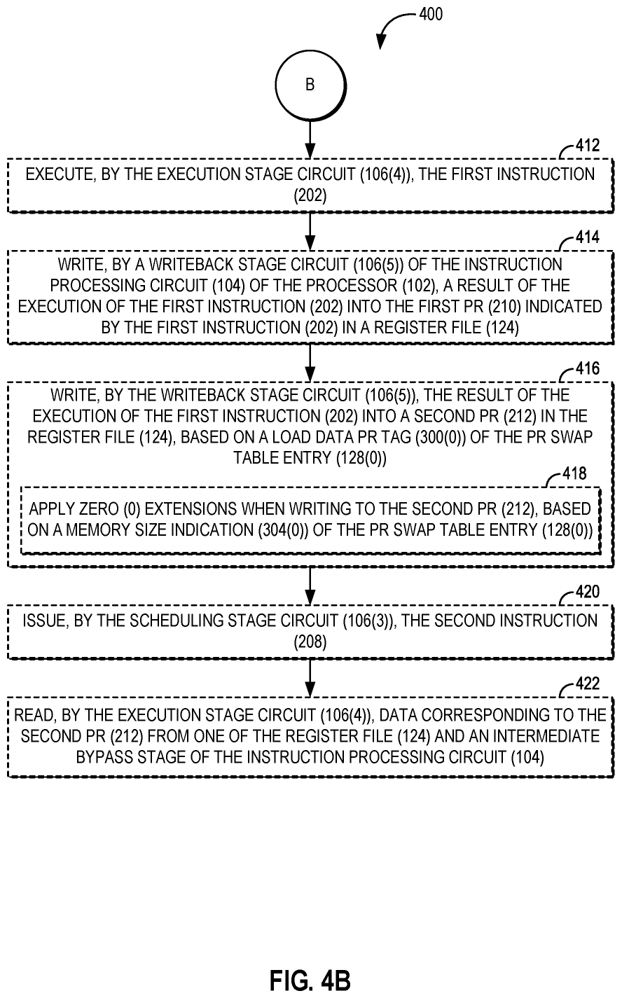

To illustrate exemplary operations for providing PR swap memory renaming in the processor-based device 100 of FIG. 1, FIGS. 4A-4B provide flowcharts illustrating exemplary operations 400. For the sake of clarity, elements of FIGS. 1, 2A-2B, and 3A-3D are referenced in describing FIGS. 4A-4B. It is to be understood that some of the exemplary operations 400 shown in FIGS. 4A-4B may be performed in an order other than that illustrated herein, and/or may be omitted.

The exemplary operations 400 begin in FIG. 4A with a scheduling stage circuit of an instruction processing circuit of a processor (such as the scheduling stage circuit 106(3) of FIGS. 1 and 2A-2B of the instruction processing circuit 104 of the processor 102 of FIG. 1) issuing a first instruction (e.g., the first instruction 202 of FIGS. 2A-2B) that is associated with a store dependency ID (such as the store dependency ID 216(0) of FIGS. 2A-2B and 3A-3D) (block 402). In response to the issuing of the first instruction 202, an execution stage circuit (e.g., the execution stage circuit 106(4) of FIG. 1) of the instruction processing circuit 104 identifies a PR swap table entry (such as the PR swap table entry 128(0) of FIGS. 1, 2A-2B, and 3A-3D) corresponding to the store dependency ID 216(0) among a plurality of PR swap table entries (such as the PR swap table entries 128(0)-128(P) of FIGS. 1 and 2A-2B) of a PR swap table (e.g., the PR swap table 126 of FIGS. 1 and 2A-2B) of the execution stage circuit 106(4) (block 404). Some aspects may provide that the operations of block 404 for identifying the PR swap table entry 128(0) may comprise the execution stage circuit 106(4) determining that a register type indication (e.g., the register type indication 302(0) of FIG. 3A) of the PR swap table entry 128(0) corresponds to a register type of a first PR (such as the PR 210 of FIGS. 2A-2B) of the first instruction 202 (block 406). The execution stage circuit 106(4) then retrieves a load dependency ID (e.g., the load dependency ID 218(0) of FIGS. 2A-2B and 3A-3D) of the PR swap table entry 128(0) (block 408). The execution stage circuit 106(4) broadcasts the load dependency ID 218(0) to a reservation station circuit (e.g., the reservation station circuit 114 of FIGS. 1 and 2A-2B) of the scheduling stage circuit 106(3) to wake a second instruction (such as the second instruction 208 of FIGS. 2A-2B) that is associated with the load dependency ID 218(0) (block 410). The exemplary operations 400 according to some aspects may continue at block 412 of FIG. 4B.

Turning now to FIG. 4B, in some aspects, the execution stage circuit 106(4) executes the first instruction 202 (block 412). A writeback stage circuit (e.g., the writeback stage circuit 106(5) of FIG. 1) of the instruction processing circuit 104 of the processor 102 writes a result of the execution of the first instruction 202 into the first PR 210 indicated by the first instruction 202 in a register file (such as the register file 124 of FIG. 1) (block 414). The writeback stage circuit 106(5) also writes the result of the execution of the first instruction 202 into a second PR (e.g., the PR 212 of FIGS. 2A-2B) in the register file 124, based on a load data PR tag (such as the load data PR tag 300(0) of FIG. 3A or the load data PR tag 308 of FIG. 3B) of the PR swap table entry 128(0) (block 416). Some aspects may provide that the operations of block 416 for writing the result of the execution of the first instruction 202 into the second PR 212 may comprise applying zero (0) extensions when writing to the second PR 212, based on a memory size indication (e.g., the memory size indication 304(0) of FIG. 3A) of the PR swap table entry 128(0) (block 418). The scheduling stage circuit 106(3) issues the second instruction 208 (block 420). The execution stage circuit 106(4) reads data corresponding to the second PR 212 from one of the register file 124 and an intermediate bypass stage of the instruction processing circuit 104 (block 422).

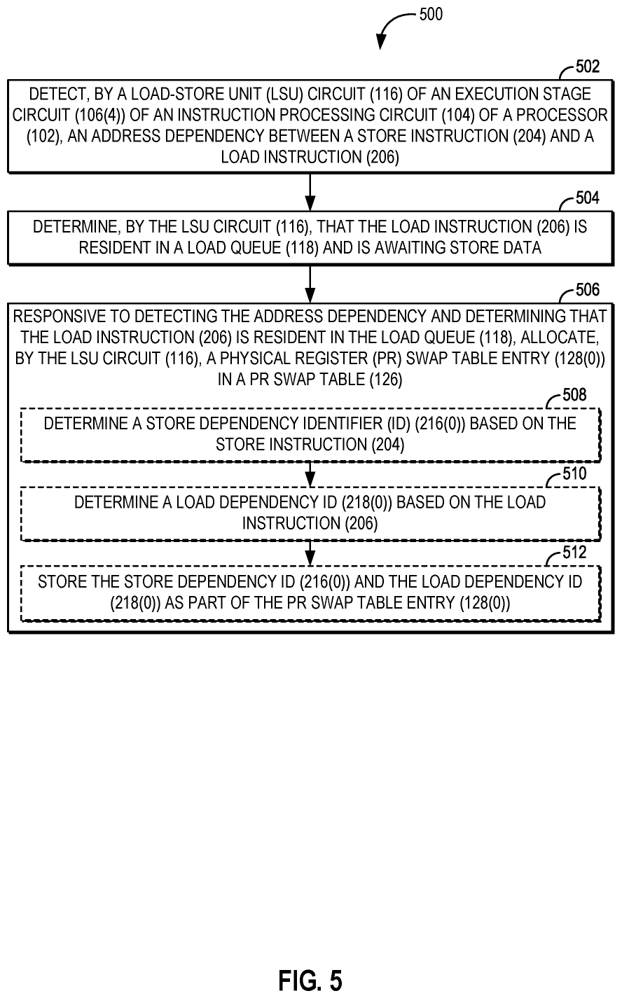

FIG. 5 provides a flowchart illustrating exemplary operations 500 for allocation of a PR swap table entry by the LSU circuit of FIG. 1, according to some aspects. Elements of FIGS. 1, 2A-2B, and 3A-3D are referenced in describing FIG. 5 for the sake of clarity. In FIG. 5 the exemplary operations 500 begin with an LSU circuit of an execution stage circuit of an instruction processing circuit of a processor (e.g., the LSU circuit 116 of the execution stage circuit 106(4) of the instruction processing circuit 104 of the processor 102 of FIG. 1) detecting an address dependency between a store instruction and a load instruction (such as the store instruction 204 and the load instruction 206 of FIGS. 2A-2B) (block 502). The LSU circuit 116 determines that the load instruction 206 is resident in a load queue (e.g., the load queue 118 of FIGS. 1 and 2A-2B) and is awaiting store data (block 504). In response to detecting the address dependency and determining that the load instruction 206 is resident in the load queue 118, the LSU circuit 116 in such aspects allocates a PR swap table entry (such as the PR swap table entry 128(0) of FIGS. 1, 2A-2B, and 3A-3D) in a PR swap table (e.g., the PR swap table 126 of FIGS. 1 and 2A-2B) (block 506). According to some such aspects, the operations of block 506 for allocating the PR swap table entry 128(0) may comprise the LSU circuit 116 determining a store dependency ID (such as the store dependency ID 216(0) of FIGS. 2A-2B and 3A-3D) based on the store instruction 204 (block 508). The LSU circuit 116 may also determine a load dependency ID (e.g., the load dependency ID 218(0) of FIGS. 2A-2B and 3A-3D) based on the load instruction 206 (block 510). The LSU circuit 116 then stores the store dependency ID 216(0) and the load dependency ID 218(0) as part of the PR swap table entry 128(0) (block 512).

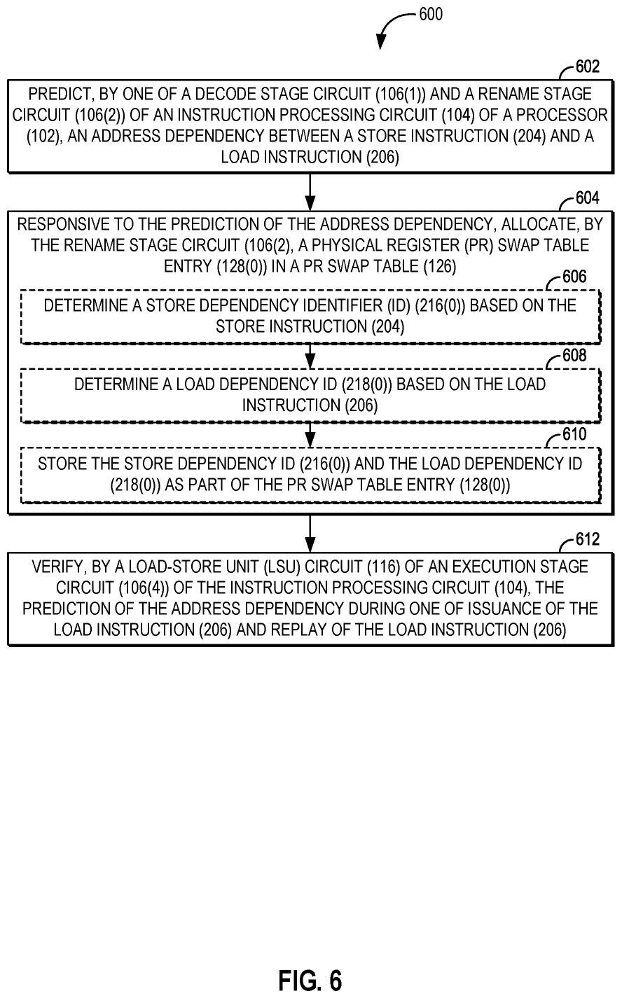

To illustrate exemplary operations for allocation of a PR swap table entry by the decode stage circuit 106(1) and/or the rename stage circuit 106(2) of FIG. 1 according to some aspects, FIG. 6 provides a flowchart illustrating exemplary operations 600. For the sake of clarity, elements of FIGS. 1, 2A-2B, and 3A-3D are referenced in describing FIG. 6. The exemplary operations 600 begin with one of a decode stage circuit and a rename stage circuit of an instruction processing circuit of a processor (e.g., one of the decode stage circuit 106(1) and the rename stage circuit 106(2) of the instruction processing circuit 104 of the processor 102 of FIG. 1) predicting an address dependency between a store instruction and a load instruction (such as the store instruction 204 and the load instruction 206 of FIGS. 2A-2B) (block 602). In response to the prediction of the address dependency, the rename stage circuit 106(2) allocates a PR swap table entry (such as the PR swap table entry 128(0) of FIGS. 1, 2A-2B, and 3A-3D) in a PR swap table (e.g., the PR swap table 126 of FIGS. 1 and 2A-2B) (block 604). In some aspects, the operations of block 604 for allocating the PR swap table entry 128(0) may comprise the rename stage circuit 106(2) determining a store dependency ID (such as the store dependency ID 216(0) of FIGS. 2A-2B and 3A-3D) based on the store instruction 204 (block 606). The rename stage circuit 106(2) may also determine a load dependency ID (e.g., the load dependency ID 218(0) of FIGS. 2A-2B and 3A-3D) based on the load instruction 206 (block 608). The rename stage circuit 106(2) then stores the store dependency ID 216(0) and the load dependency ID 218(0) as part of the PR swap table entry 128(0) (block 610). Subsequently, an LSU circuit of an execution stage circuit (e.g., the LSU circuit 116 of the execution stage circuit 106(4)) of the instruction processing circuit 104 verifies the prediction of the address dependency during one of issuance of the load instruction 206 and replay of the load instruction 206 (block 612).

Providing PR swap memory renaming according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

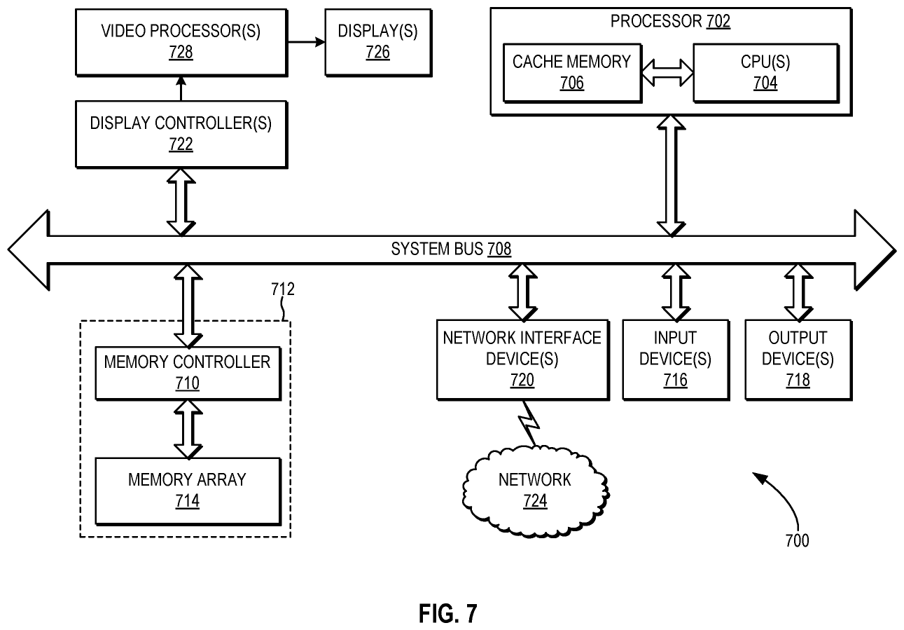

In this regard, FIG. 7 illustrates an example of a processor-based device 700 that may comprise the processor-based device 100 illustrated in FIG. 1. In this example, the processor-based device 700 includes a processor 702 that includes one or more central processing units (captioned as “CPUs” in FIG. 7) 704, which may also be referred to as CPU cores or processor cores. The processor 702 may have cache memory 706 coupled to the processor 702 for rapid access to temporarily stored data. The processor 702 is coupled to a system bus 708 and can intercouple master and slave devices included in the processor-based device 700. As is well known, the processor 702 communicates with these other devices by exchanging address, control, and data information over the system bus 708. For example, the processor 702 can communicate bus transaction requests to a memory controller 710, as an example of a slave device. Although not illustrated in FIG. 7, multiple system buses 708 could be provided, wherein each system bus 708 constitutes a different fabric.

Other master and slave devices can be connected to the system bus 708. As illustrated in FIG. 7, these devices can include a memory system 712 that includes the memory controller 710 and a memory array(s) 714, one or more input devices 716, one or more output devices 718, one or more network interface devices 720, and one or more display controllers 722, as examples. The input device(s) 716 can include any type of input device, including but not limited to input keys, switches, voice processors, etc. The output device(s) 718 can include any type of output device, including, but not limited to, audio, video, other visual indicators, etc. The network interface device(s) 720 can be any device configured to allow exchange of data to and from a network 724. The network 724 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 720 can be configured to support any type of communications protocol desired.

The processor 702 may also be configured to access the display controller(s) 722 over the system bus 708 to control information sent to one or more displays 726. The display controller(s) 722 sends information to the display(s) 726 to be displayed via one or more video processors 728, which process the information to be displayed into a format suitable for the display(s) 726. The display(s) 726 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
a processor comprising an instruction processing circuit comprising a plurality of pipeline stage circuits including a scheduling stage circuit and an execution stage circuit;
the scheduling stage circuit comprising a reservation station circuit;
the execution stage circuit comprising a physical register (PR) swap table storing a plurality of PR swap table entries;
the scheduling stage circuit configured to issue a first instruction that is associated with a store dependency identifier (ID); and
the execution stage circuit configured to, responsive to the issuing of the first instruction:
   identify a PR swap table entry corresponding to the store dependency ID among the plurality of PR swap table entries of the PR swap table;
   retrieve a load dependency ID of the PR swap table entry; and
   broadcast the load dependency ID to the reservation station circuit to wake a second instruction that is associated with the load dependency ID.
      2. The processor-based device of clause 1, wherein:
the execution stage circuit further comprises a load-store unit (LSU) circuit comprising a load queue; and
the LSU circuit is configured to:
   detect an address dependency between a store instruction and a load instruction;
   determine that the load instruction is resident in the load queue and is awaiting store data; and
   responsive to detecting the address dependency and determining that the load instruction is resident in the load queue, allocate the PR swap table entry in the PR swap table by being configured to:
      determine the store dependency ID based on the store instruction;
      determine the load dependency ID based on the load instruction; and
      store the store dependency ID and the load dependency ID as part of the PR swap table entry.
         3. The processor-based device of clause 1, wherein:
the plurality of pipeline stage circuits further includes a decode stage circuit and a rename stage circuit;
the execution stage circuit further comprises a load-store unit (LSU) circuit;
one of the decode stage circuit and the rename stage circuit is configured to predict an address dependency between a store instruction and a load instruction;
the rename stage circuit is configured to, responsive to the prediction of the address dependency, allocate the PR swap table entry in the PR swap table by being configured to:
   determine the store dependency ID based on the store instruction;
   determine the load dependency ID based on the load instruction; and
   store the store dependency ID and the load dependency ID as part of the PR swap table entry; and
the LSU circuit is configured to verify the prediction of the address dependency during one of issuance of the load instruction and replay of the load instruction.
   4. The processor-based device of any one of clauses 2-3, wherein:
the store dependency ID of the PR swap table entry comprises a store data PR tag of the store instruction; and
the load dependency ID of the PR swap table entry comprises a load data PR tag of the load instruction.
   5. The processor-based device of any one of clauses 2-3, wherein:
the store dependency ID of the PR swap table entry comprises one of a reorder buffer (ROB) ID and a scheduler ID of the store instruction; and
the load dependency ID of the PR swap table entry comprises one of a ROB ID and a scheduler ID of the load instruction.
   6. The processor-based device of any one of clauses 1-5, wherein:
the PR swap table entry comprises a load data PR tag of a load instruction;
the plurality of pipeline stage circuits further includes a writeback stage circuit;
the execution stage circuit is further configured to execute the first instruction; and
the writeback stage circuit is configured to:
   write a result of the execution of the first instruction into a first PR indicated by the first instruction in a register file; and
   write the result of the execution of the first instruction into a second PR in the register file, based on the load data PR tag of the PR swap table entry.
      7. The processor-based device of clause 6, wherein the scheduling stage circuit is further configured to:
issue the second instruction; and
read data corresponding to the second PR from one of the register file and an intermediate bypass stage of the instruction processing circuit.
   8. The processor-based device of clause 6, wherein:
the PR swap table entry further comprises a memory size indication; and
the writeback stage circuit is configured to write the result of the execution of the first instruction into the second PR in the register file by being configured to apply zero (0) extensions when writing to the second PR and an intermediate bypass stage of the instruction processing circuit, based on the memory size indication.
   9. The processor-based device of clause 6, wherein:
the PR swap table entry further comprises a register type indication;
the execution stage circuit is configured to identify the PR swap table entry by being configured to determine that the register type indication of the PR swap table entry corresponds to a register type of a first PR of the first instruction; and
the register file comprises one of an integer register file and a vector register file indicated by the register type indication.
   10. The processor-based device of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
   11. A processor-based device, comprising:
means for issuing a first instruction that is associated with a store dependency identifier (ID);
means for identifying a physical register (PR) swap table entry corresponding to the store dependency ID among a plurality of PR swap table entries of a PR swap table, responsive to the issuing of the first instruction;
means for retrieving a load dependency ID of the PR swap table entry; and
means for broadcasting the load dependency ID to a reservation station circuit to wake a second instruction that is associated with the load dependency ID.
   12. A method for providing physical register (PR) swap memory renaming, comprising:
issuing, by a scheduling stage circuit of an instruction processing circuit of a processor, a first instruction that is associated with a store dependency identifier (ID);
responsive to the issuing of the first instruction, identifying, by an execution stage circuit of the instruction processing circuit of the processor, a PR swap table entry corresponding to the store dependency ID among a plurality of PR swap table entries of a PR swap table of the execution stage circuit;
retrieving, by the execution stage circuit, a load dependency ID of the PR swap table entry; and
broadcasting, by the execution stage circuit, the load dependency ID to a reservation station circuit of the scheduling stage circuit to wake a second instruction that is associated with the load dependency ID.
   13. The method of clause 12, further comprising:
detecting, by a load-store unit (LSU) circuit of the execution stage circuit, an address dependency between a store instruction and a load instruction;
determining, by the LSU circuit, that the load instruction is resident in a load queue and is awaiting store data; and
responsive to detecting the address dependency and determining that the load instruction is resident in the load queue, allocating, by the LSU circuit, the PR swap table entry in the PR swap table by:
   determining the store dependency ID based on the store instruction;
   determining the load dependency ID based on the load instruction; and
   storing the store dependency ID and the load dependency ID as part of the PR swap table entry.
      14. The method of clause 12, wherein:
predicting, by one of a decode stage circuit and a rename stage circuit of the instruction processing circuit of the processor, an address dependency between a store instruction and a load instruction;
responsive to the prediction of the address dependency, allocating, by the rename stage circuit, the PR swap table entry in the PR swap table by:
   determining the store dependency ID based on the store instruction;
   determining the load dependency ID based on the load instruction; and
   storing the store dependency ID and the load dependency ID as part of the PR swap table entry; and
verifying, by a load-store unit (LSU) circuit of the execution stage circuit, the prediction of the address dependency during one of issuance of the load instruction and replay of the load instruction.
   15. The method of any one of clauses 13-14, wherein:
the store dependency ID of the PR swap table entry comprises a store data PR tag of the store instruction; and
the load dependency ID of the PR swap table entry comprises a load data PR tag of the load instruction.
   16. The method of any one of clauses 13-14, wherein:
the store dependency ID of the PR swap table entry comprises one of a reorder buffer (ROB) ID and a scheduler ID of the store instruction; and
the load dependency ID of the PR swap table entry comprises one of a ROB ID and a scheduler ID of the load instruction.
   17. The method of any one of clauses 12-16, wherein:
the PR swap table entry comprises a load data PR tag of a load instruction; and
the method further comprises:
   executing, by the execution stage circuit, the first instruction;
   writing, by a writeback stage circuit of the instruction processing circuit of the processor, a result of the execution of the first instruction into a first PR indicated by the first instruction in a register file; and
   writing, by the writeback stage circuit, the result of the execution of the first instruction into a second PR in the register file, based on the load data PR tag of the PR swap table entry.
      18. The method of any one of clauses 12-16, further comprising:
issuing, by the scheduling stage circuit, the second instruction; and
reading, by the scheduling stage circuit, data corresponding to the second PR from one of the register file and an intermediate bypass stage of the instruction processing circuit.
   19. The method of clause 17, wherein:
the PR swap table entry further comprises a memory size indication; and
writing the result of the execution of the first instruction into the second PR in the register file comprises applying zero (0) extensions when writing to the second PR, based on the memory size indication.
   20. The method of clause 17, wherein:
the PR swap table entry further comprises a register type indication;
identifying the PR swap table entry comprises determining that the register type indication of the PR swap table entry corresponds to a register type of a first PR of the first instruction; and
the register file comprises one of an integer register file and a vector register file indicated by the register type indication.
   21. A non-transitory computer-readable medium having stored thereon computer-executable instructions that, when executed, cause a processor of a processor-based device to:
issue a first instruction that is associated with a store dependency identifier (ID);
identify a physical register (PR) swap table entry corresponding to the store dependency ID among a plurality of PR swap table entries of a PR swap table, responsive to the issuing of the first instruction;
retrieve a load dependency ID of the PR swap table entry; and
broadcast the load dependency ID to a reservation station circuit to wake a second instruction that is associated with the load dependency ID.
   22. The non-transitory computer-readable medium of clause 21, wherein the computer-executable instructions further cause the processor to:
detect an address dependency between a store instruction and a load instruction;
determine that the load instruction is resident in a load queue and is awaiting store data; and
responsive to detecting the address dependency and determining that the load instruction is resident in the load queue, allocate the PR swap table entry in the PR swap table by causing the processor to:
   determine the store dependency ID based on the store instruction;
   determine the load dependency ID based on the load instruction; and
   store the store dependency ID and the load dependency ID as part of the PR swap table entry.
      23. The non-transitory computer-readable medium of clause 21, wherein the computer-executable instructions further cause the processor to:
predict an address dependency between a store instruction and a load instruction;
responsive to the prediction of the address dependency, allocate the PR swap table entry in the PR swap table by causing the processor to:
   determine the store dependency ID based on the store instruction;
   determine the load dependency ID based on the load instruction; and
   store the store dependency ID and the load dependency ID as part of the PR swap table entry; and
verify the prediction of the address dependency during one of issuance of the load instruction and replay of the load instruction.

What is claimed is:

1. A processor-based device, comprising:
a processor comprising an instruction processing circuit comprising a plurality of pipeline stage circuits including a scheduling stage circuit and an execution stage circuit;
the scheduling stage circuit comprising a reservation station circuit;
the execution stage circuit comprising a physical register (PR) swap table storing a plurality of PR swap table entries;
the scheduling stage circuit configured to issue a first instruction that is associated with a store dependency identifier (ID); and
the execution stage circuit configured to, responsive to the issuing of the first instruction:
identify a PR swap table entry corresponding to the store dependency ID among the plurality of PR swap table entries of the PR swap table;
retrieve a load dependency ID of the PR swap table entry; and
broadcast the load dependency ID to the reservation station circuit to wake a second instruction that is associated with the load dependency ID.

2. The processor-based device of claim 1, wherein:
the execution stage circuit further comprises a load-store unit (LSU) circuit comprising a load queue; and
the LSU circuit is configured to:
detect an address dependency between a store instruction and a load instruction;
determine that the load instruction is resident in the load queue and is awaiting store data; and
responsive to detecting the address dependency and determining that the load instruction is resident in the load queue, allocate the PR swap table entry in the PR swap table by being configured to:
determine the store dependency ID based on the store instruction;
determine the load dependency ID based on the load instruction; and
store the store dependency ID and the load dependency ID as part of the PR swap table entry.

3. The processor-based device of claim 1, wherein:
the plurality of pipeline stage circuits further includes a decode stage circuit and a rename stage circuit;
the execution stage circuit further comprises a load-store unit (LSU) circuit;
one of the decode stage circuit and the rename stage circuit is configured to predict an address dependency between a store instruction and a load instruction;
the rename stage circuit is configured to, responsive to the prediction of the address dependency, allocate the PR swap table entry in the PR swap table by being configured to:
determine the store dependency ID based on the store instruction;
determine the load dependency ID based on the load instruction; and
store the store dependency ID and the load dependency ID as part of the PR swap table entry; and
the LSU circuit is configured to verify the prediction of the address dependency during one of issuance of the load instruction and replay of the load instruction.

4. The processor-based device of claim 2, wherein:
the store dependency ID of the PR swap table entry comprises a store data PR tag of the store instruction; and
the load dependency ID of the PR swap table entry comprises a load data PR tag of the load instruction.

5. The processor-based device of claim 2, wherein:
the store dependency ID of the PR swap table entry comprises one of a reorder buffer (ROB) ID and a scheduler ID of the store instruction; and
the load dependency ID of the PR swap table entry comprises one of a ROB ID and a scheduler ID of the load instruction.

6. The processor-based device of claim 1, wherein:
the PR swap table entry comprises a load data PR tag of a load instruction;
the plurality of pipeline stage circuits further includes a writeback stage circuit;
the execution stage circuit is further configured to execute the first instruction; and
the writeback stage circuit is configured to:
write a result of the execution of the first instruction into a first PR indicated by the first instruction in a register file; and
write the result of the execution of the first instruction into a second PR in the register file, based on the load data PR tag of the PR swap table entry.

7. The processor-based device of claim 6, wherein the scheduling stage circuit is further configured to:
issue the second instruction; and
read data corresponding to the second PR from one of the register file and an intermediate bypass stage of the instruction processing circuit.

8. The processor-based device of claim 6, wherein:
the PR swap table entry further comprises a memory size indication; and
the writeback stage circuit is configured to write the result of the execution of the first instruction into the second PR in the register file by being configured to apply zero (0) extensions when writing to the second PR and an intermediate bypass stage of the instruction processing circuit, based on the memory size indication.

9. The processor-based device of claim 6, wherein:
the PR swap table entry further comprises a register type indication;
the execution stage circuit is configured to identify the PR swap table entry by being configured to determine that the register type indication of the PR swap table entry corresponds to a register type of a first PR of the first instruction; and
the register file comprises one of an integer register file and a vector register file indicated by the register type indication.

10. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based device, comprising:
means for issuing a first instruction that is associated with a store dependency identifier (ID);
means for identifying a physical register (PR) swap table entry corresponding to the store dependency ID among a plurality of PR swap table entries of a PR swap table, responsive to the issuing of the first instruction;
means for retrieving a load dependency ID of the PR swap table entry; and
means for broadcasting the load dependency ID to a reservation station circuit to wake a second instruction that is associated with the load dependency ID.

12. A method for providing physical register (PR) swap memory renaming, comprising:
issuing, by a scheduling stage circuit of an instruction processing circuit of a processor, a first instruction that is associated with a store dependency identifier (ID);
responsive to the issuing of the first instruction, identifying, by an execution stage circuit of the instruction processing circuit of the processor, a PR swap table entry corresponding to the store dependency ID among a plurality of PR swap table entries of a PR swap table of the execution stage circuit;
retrieving, by the execution stage circuit, a load dependency ID of the PR swap table entry; and
broadcasting, by the execution stage circuit, the load dependency ID to a reservation station circuit of the scheduling stage circuit to wake a second instruction that is associated with the load dependency ID.

13. The method of claim 12, further comprising:
detecting, by a load-store unit (LSU) circuit of the execution stage circuit, an address dependency between a store instruction and a load instruction;
determining, by the LSU circuit, that the load instruction is resident in a load queue and is awaiting store data; and
responsive to detecting the address dependency and determining that the load instruction is resident in the load queue, allocating, by the LSU circuit, the PR swap table entry in the PR swap table by:
determining the store dependency ID based on the store instruction;
determining the load dependency ID based on the load instruction; and
storing the store dependency ID and the load dependency ID as part of the PR swap table entry.

14. The method of claim 12, wherein:
predicting, by one of a decode stage circuit and a rename stage circuit of the instruction processing circuit of the processor, an address dependency between a store instruction and a load instruction;
responsive to the prediction of the address dependency, allocating, by the rename stage circuit, the PR swap table entry in the PR swap table by:
determining the store dependency ID based on the store instruction;
determining the load dependency ID based on the load instruction; and
storing the store dependency ID and the load dependency ID as part of the PR swap table entry; and
verifying, by a load-store unit (LSU) circuit of the execution stage circuit, the prediction of the address dependency during one of issuance of the load instruction and replay of the load instruction.

15. The method of claim 13, wherein:
the store dependency ID of the PR swap table entry comprises a store data PR tag of the store instruction; and
the load dependency ID of the PR swap table entry comprises a load data PR tag of the load instruction.

16. The method of claim 13, wherein:
the store dependency ID of the PR swap table entry comprises one of a reorder buffer (ROB) ID and a scheduler ID of the store instruction; and
the load dependency ID of the PR swap table entry comprises one of a ROB ID and a scheduler ID of the load instruction.

17. The method of claim 12, wherein:
the PR swap table entry comprises a load data PR tag of a load instruction; and
the method further comprises:
executing, by the execution stage circuit, the first instruction;
writing, by a writeback stage circuit of the instruction processing circuit of the processor, a result of the execution of the first instruction into a first PR indicated by the first instruction in a register file; and
writing, by the writeback stage circuit, the result of the execution of the first instruction into a second PR in the register file, based on the load data PR tag of the PR swap table entry.

18. The method of claim 16, further comprising:
issuing, by the scheduling stage circuit, the second instruction; and
reading, by the scheduling stage circuit, data corresponding to the second PR from one of the register file and an intermediate bypass stage of the instruction processing circuit.

19. The method of claim 17, wherein:
the PR swap table entry further comprises a memory size indication; and
writing the result of the execution of the first instruction into the second PR in the register file comprises applying zero (0) extensions when writing to the second PR, based on the memory size indication.

20. The method of claim 17, wherein:
the PR swap table entry further comprises a register type indication;
identifying the PR swap table entry comprises determining that the register type indication of the PR swap table entry corresponds to a register type of a first PR of the first instruction; and
the register file comprises one of an integer register file and a vector register file indicated by the register type indication.

21. A non-transitory computer-readable medium having stored thereon computer-executable instructions that, when executed, cause a processor of a processor-based device to:
issue a first instruction that is associated with a store dependency identifier (ID);
identify a physical register (PR) swap table entry corresponding to the store dependency ID among a plurality of PR swap table entries of a PR swap table, responsive to the issuing of the first instruction;
retrieve a load dependency ID of the PR swap table entry; and
broadcast the load dependency ID to a reservation station circuit to wake a second instruction that is associated with the load dependency ID.

22. The non-transitory computer-readable medium of claim 21, wherein the computer-executable instructions further cause the processor to:
detect an address dependency between a store instruction and a load instruction;
determine that the load instruction is resident in a load queue and is awaiting store data; and
responsive to detecting the address dependency and determining that the load instruction is resident in the load queue, allocate the PR swap table entry in the PR swap table by causing the processor to:
determine the store dependency ID based on the store instruction;
determine the load dependency ID based on the load instruction; and
store the store dependency ID and the load dependency ID as part of the PR swap table entry.

23. The non-transitory computer-readable medium of claim 21, wherein the computer-executable instructions further cause the processor to:
predict an address dependency between a store instruction and a load instruction;
responsive to the prediction of the address dependency, allocate the PR swap table entry in the PR swap table by causing the processor to:
determine the store dependency ID based on the store instruction;
determine the load dependency ID based on the load instruction; and
store the store dependency ID and the load dependency ID as part of the PR swap table entry; and
verify the prediction of the address dependency during one of issuance of the load instruction and replay of the load instruction.
